(19) United States
(12) Patent Application Publication
(10) Pub. No.: US 2018/0007515 A1
(43) Pub. Date: Jan. 4, 2018

(54) PROCESSING SPATIAL FEATURES

(71) Applicant: SENSEWHERE LIMITED, Edinburgh (GB)

(72) Inventors: Tughrul Sati ARSLAN, Edinburgh (GB); Zankar Upendrakumar SEVAK, Edinburgh (GB); Firas ALSEHLY, Edinburgh (GB)

(21) Appl. No.: 15/522,370

(22) PCT Filed: Sep. 25, 2015
(86) PCT No.: PCT/GB2015/052798

§ 371 Date: Apr. 27, 2017

Related U.S. Application Data
(60) Provisional application No. 62/068,895, filed on Oct. 27, 2014.

(51) Int. Cl. H04W 4/04; G01C 21/32; G01C 21/20

(52) U.S. Cl. CPC H04W 4/043; G01C 21/206; G01C 21/32

(57) ABSTRACT

There is disclosed a method of updating a database of spatial features, said spatial features being associated with a region, and the method comprising: receiving positioning data that has been collected at a plurality of locations within the region; processing the collected positioning data to identify at least one candidate spatial feature associated with the region; identifying at least one other spatial feature corresponding to said at least one candidate spatial feature, said at least one other spatial feature and said at least one candidate spatial feature as a whole constituting matching spatial features; processing said matching spatial features; and updating the database of spatial features in dependence on the processing of said matching spatial features.

### FIELD OF THE INVENTION

The present invention relates to (but is not limited to) autonomously identifying indoor spatial features, for example by crowd-sourcing.

### BACKGROUND TO THE INVENTION

Various methods exist to allow the user of a mobile device (such as a smartphone) to estimate the location of the device. Devices may, for example, include a positioning module, such as a Global Navigation Satellite System (GNSS) which provides an estimate of a user's absolute position. Other systems, such as Pedometer Dead Reckoning (PDR) systems, provide an estimate of the user's relative position, which can be combined with previous absolute position estimates to provide a current, real-time position estimate. A further class of positioning system carries out range-finding on electromagnetic signals received at the device, and combines the range data with predetermined information about the sources of the signals (such as their location) to produce a position estimate.

The GNSS and similar systems can produce relatively accurate position estimates, but are limited in that they typically do not function indoors. The relative positioning systems (such as PDR) and range-finding systems (such as Wi-Fi location systems) are relatively less accurate, but are typically the only systems which provide meaningful results indoors. The accuracy of range-finding positioning is limited by factors such as multi-path interference, attenuation by walls, and the like, which can result in poor performance even when the location of electromagnetic signal sources (such as Wireless Access Points, WAPs) is known precisely.

The accuracy of range-finding positioning systems can be improved by ‘war-walking’ in the vicinity of the above-mentioned electromagnetic signal sources, so as to assist in mapping particular received signals to a particular location within a building. This can be done as part of a ‘crowd-sourcing’ initiative, whereby a number of users contribute data over time, allowing refinement of the location database. Results can be improved further by using the received crowd-sourced data to create/refine a map of features of a particular building, so as to model the interference effects and so on. However, it is generally very difficult and inconvenient to have the war-walking/crowd-sourcing done in a structured and rigorous fashion, thus preventing the easy modelling of building features and the like.

The present invention seeks to address deficiencies in the prior art.

### SUMMARY OF THE INVENTION

In a first aspect of the invention, there is provided a method of updating a database of spatial features, said spatial features being associated with a region, and the method comprising: receiving positioning data that has been collected at a plurality of locations within the region; processing the collected positioning data to identify at least one candidate spatial feature (such as a path and/or node) associated with the region; identifying at least one other spatial feature corresponding to said at least one candidate spatial feature, said at least one other spatial feature and said at least one candidate spatial feature as a whole constituting matching spatial features; processing said matching spatial features; and updating the database of spatial features (preferably by updating existing records or creating new entries in the database, as appropriate) in dependence on the processing of said matching spatial features. This provides a way to process (additional) positioning data, such as that received from crowd-sourcing, to update databases of spatial features.

The positioning data may include at least one of a position estimate and/or measurement data. By measurement data we refer to raw or intermediate data such as may be received by a positioning module and used in the computation of the position estimate (and as such distinct from the position estimate). Thus in the case of an electromagnetic (EM) signal positioning module, the position estimate may for example include an approximate 2D or 3D position in space, and the measurement data may, for example, include signal identifiers (such as SSID), signal strength measurements, and the like. A pedometer dead reckoning (PDR) positioning system may likewise report an absolute 2D or 3D position, or a relative vector position, and its measurement data may include, for example, accelerometer readings, gyroscope readings, compass measurements and intermediate data such as pacing measurements (which may be deduced from said accelerometer readings and the like). Further types of positioning systems are mentioned below; in these cases measurement data may for example include visual or infrared images (device camera), sound amplitudes, delays and/or waveforms (ultrasound detector), and so on.

The step of identifying at least one other spatial feature may comprise deriving at least one spatial feature from additional positioning data collected within the region. The positioning data may be collected (at least partially) at the same or (at least partially) at a further plurality of locations. The additional positioning data may be received at (or transmitted by) the same device or system as for the positioning data, or by a different device (operated by the same or a different user).

Preferably a correlation algorithm is applied to the spatial features (that is, is applied to the said one or more candidate spatial features and one or more other spatial features including the said at least one other spatial feature) with appropriate inputs. Data relating to the at least one other spatial feature may be received from another system, and/or may be included in ‘third party’ data that may be purchased by the operator of the present system, or otherwise, for example.

The step of identifying at least one other spatial feature may comprise accessing the database to identify within the database at least one stored spatial feature corresponding to said at least one candidate spatial feature.

The data in the database associated with said at least one stored spatial feature (or any other spatial feature) preferably relates to one or more properties of said at least one stored spatial feature, and is preferably an estimate, such as an estimate of start or end position, length, height, shape, relationship with other spatial features, and so on. A candidate spatial feature may represent an estimate of at least one property of a spatial feature, as above. For example, a candidate node may be an estimate of the location of the node in 2D or 3D space, and a candidate path may be an estimate of the start and end point and may also include intermediate points, curve information, and so on.

The method may further comprise receiving geographical data relating to a geographical region in the vicinity of the region (or a path taken through the region by a user and/or a mobile user device associated with the user), and wherein identifying at least one other spatial feature comprises deriving (including identifying or generating as appropriate) said at least one other spatial feature from the geographical data.

The geographical data may in particular include data representing at least one spatial feature. Accordingly, processing said matching spatial features may comprise comparing the position of said at least one candidate spatial feature with the position of said at least one spatial feature.

The geographical data may also define at least one spatial feature corresponding to an access point of a building (here access point refers to any entrance or exit from the building, and the like, which may be expected to be traversed by a user). In this or in other cases, at least some of said at least one candidate spatial features may be inside a (or the aforementioned) building and the geographical data may define at least one spatial feature outside the building. These features can assist the post-processing of matching spatial features and/or estimated paths within the building so as to relate them to spatial features (such as building access points and features external to the building where positioning can be more accurately carried out) having a more accurate or certain/known location.

If at least some of said at least one candidate spatial features are inside a building, the geographical data may define at least one spatial feature outside the building, in which case a partial update of the matching spatial features and/or database of spatial features may be carried out. Preferably, however, the geographical data includes spatial or other features inside the building, in appropriate GIS format for example.

The method may further comprise processing said matching spatial features using the geographical data to validate or adjust said matching spatial features. In this and in any related aspect, processing the matching spatial features may be carried out at any appropriate local, for example at a user handset or on a server which may be a positioning server or computer system connected thereto. In this and any other aspects, this processing may be carried out after the end of a session in which the positioning data is collected (or in other cases at least partly during the session).

The geographical data may include at least one recorded path (preferably one or more ‘ground truth routes’, or recorded paths having a relatively high and/or verified/validated accuracy), in which case processing said matching spatial features may comprise validating or adjusting said matching spatial features in dependent on said at least one recorded path (or ‘ground truth route’). In this way, the method may further comprise correlating said matching spatial features with at least one position in said at least one recorded path to determine a quality measure associated with said matching spatial features; for example if the estimated position of (one or more) matching spatial features closely match positions on a recorded route then the matching spatial features can be assigned a relatively high quality measure. Additionally or alternatively, the method may further comprise revising (one or more of) said matching spatial features in dependence on said at least one position in said at least one recorded path. Thus a single recorded path can be used to improve the accuracy of the matching spatial features, and/or a number of recorded paths/ground truth routes can be fused, for example subject to passing a threshold quality measure (which may be a quality measure as aforesaid). The estimates can be revised to create spatial features which are best fit to all the considered paths (recorded and recently measured), and so on.

In any case in which a quality measure is assessed, of individual position estimates and/or partial or whole path elements, if a quality falls below an appropriate threshold an alarm signal may be generated, for example to trigger the removal of apparently incorrect spatial features or to notify map owners/maintainers.

The method may further comprise processing said matching spatial features to better match the said geographical descriptive data, for example to snap the revised position of (one or more of) the matching spatial features to a pathway, walkway, corridor, room or pavement known from the geographical descriptive (mapping) data.

The step of processing said matching spatial features preferably further comprises generating at least one composite spatial feature in dependence on said matching spatial features, and updating the database of spatial features includes storing said composite spatial feature in the database. The term ‘composite’ is not intended to be limiting, and merely denote that the composite spatial feature arises from processing multiple spatial features.

In a related aspect of the invention, there is provided a method of (automatically) identifying a spatial feature of an indoor region (and/or a method of creating and/or maintaining a spatial features database storing data representing one or more spatial features of an indoor region), the method comprising: collecting (for example, over a navigation session) positioning data relating to an indoor region from a mobile device; identifying one or more candidate spatial features of the indoor region from the collected positioning data; and correlating the said one or more candidate spatial features with one or more other candidate spatial features to determine two or more matching candidate spatial features (that is, candidate spatial features which have been determined to relate to the same spatial feature of the indoor region). The indoor region may for example be one which the mobile device occupies, moves through or towards. The other candidate spatial features may be provided in a local pool of spatial feature data stored on the mobile device or a central pool of spatial feature data stored on one or more servers in data communication with the mobile device). The method preferably further comprises using the matching candidate spatial features to selectively update a spatial features database.

Preferably the positioning data is received from at least one positioning module (such as a Global Navigation Satellite System, Wi-Fi subsystem, Pedometer Dead Reckoning system, and so on) in a mobile device. Preferably, in particular, said at least one positioning module comprises at least one of: a satellite positioning system module (such as GNSS), a wireless positioning system module (such as a WiFi positioning system) using signals detected from terrestrial electromagnetic signal sources, a pedometer dead reckoning (PDR) positioning system module, and so on. Other possible types of positioning module include: a camera or other imaging device, for example matching captured visible or infrared images with known or estimated geographical features, ultrasound or other sonic systems for ranging and detection of environmental features, time of flight cameras, for obtaining depth information, and so on. The term positioning module may envisage any module, physically located on a user device or otherwise, which is capable of making at least one measurement from which a relative or absolute position may be estimated or inferred.

The positioning data may be pre-processed (which is to say, subject to an additional processing step) to combine different positioning module data into a single position or other estimate, and so on, for example corresponding to the position estimate as aforesaid. Alternatively the positioning data may be in a ‘raw’ form as received from the positioning module, corresponding to the measurement data as aforesaid. Preferably the processing steps are carried out partially or wholly on said mobile device, but may be carried out partially or fully remote from the mobile device, for example at a remote server, which may be a location server in a telephone or other network.

It may be that said matching candidate spatial features are derived from positioning data relating to (e.g. obtained by) one or more mobile devices approaching and/or passing through a spatial feature at different angles and/or from different directions.

The database of spatial features may include stored positioning data associated with said at least one stored spatial feature, in which case the step of processing said at least one candidate spatial feature and said at least one stored spatial feature includes processing said stored positioning data. The additional information provided by stored positioning data can assist in the estimation of properties of the relevant spatial feature(s). In addition, the method may comprise filtering the stored positioning data to identify anomalous or outdated positioning data, and consequently to identify anomalous or outdated spatial features (for example if the structure of a building is changed), once sufficient additional positioning data is received. In addition, individual elements of the positioning data can retrospectively be identified as unreliable or otherwise excluded from the processing, potentially leading to better results than if only the resulting spatial feature estimations were retained.

The method may further comprise storing at least a portion of (that is, part of or all of) the collected positioning data in the database of spatial features, preferably by combining it with the (original) stored positioning data. Thus in a subsequent iteration of the method, the collected positioning data (or part thereof) may be used in addition to the original stored positioning data so as to give an improved new estimate of relevant properties of the relevant spatial features.

Typically a signal measurement profile is associated with each candidate spatial feature. Preferably the signal measurement profile is an electromagnetic signal profile, but may alternatively be a visual or other profile relating to magnetic and other readings, and may for example include images or other visual data/measurements, for example relating to features of the environment imaged as part of the data collection process and/or reference visual features associated with to that location. In one example, the signal measurement profile may include distance or depth readings from ultrasonic or other measurement systems. In particular, the electromagnetic signal profile may include measurements relating to electromagnetic signal sources detected in the vicinity of the spatial feature, such measurements for example relating to signal strength and identifier, and having associated statistical data. Preferably the quality assessment as aforesaid is computed in dependence on the signal measurement profile, and also preferably the signal measurement profile is stored in conjunction with the candidate spatial feature(s), other spatial features or matching spatial features, as appropriate. The signal measurement profile may include data in respect of a plurality of signal or measurement sources, and said sources may be included more than once in the signal measurement profile in some instances. The signal measurement profile may include data relating to a propagation model/path loss model, and the signal sources may include (but are not limited to) Wi-Fi access points, mobile telephone base stations, Bluetooth® beacons, and other electromagnetic sources.

Thus the signal measurement profile preferably includes at least one of: electromagnetic signal strength measurements, identifiers associated with electromagnetic signal sources, environmental mapping, distance measurements, image data, acoustic data, data quality assessments, propagation model parameters, and path loss parameters.

Preferably the aforesaid correlation algorithm (or other algorithm, device or process) carries out the correlation between spatial features in dependence on at least the signal measurement profile as aforesaid.

The method may further comprise assigning each candidate spatial feature to at least one of a plurality of groups of candidate spatial features.

Preferably each candidate spatial feature is assigned to a respective one of said groups of candidate spatial features in dependence on its similarity to other candidate spatial features in the same group. The similarity may be determined in terms of determined location or geographical area, similarity of signal measurement profile, similarity of images captured by a device, and so on.

Each group may correspond to a geographical sub-division of the region, such as a floor, building, office unit, room, corridor, and so on. A candidate feature may typically be added to only one group (though can optionally be added to more than one if appropriate), which can reduce processing requirements. The grouping need only be approximate but usefully corresponds to different areas in a building such as different floors, where locations are naturally segregated, increasing the efficiency of the process.

Processing the collected positioning data may comprise identifying a plurality of said locations as node locations, and generating node spatial features corresponding to said node locations. Nodes may be key points within an estimated path, such as turning points (locations where a path changes relatively sharply) and floor-changing spatial features (such as stairs, elevators, and so on). The method may further comprise identifying locations intermediate said node locations. In particular, processing the collected positioning data preferably further comprises identifying locations intermediate node locations as path locations, and generating path spatial features corresponding to said path locations. Preferably all path locations intermediate two node locations are transformed into a single path spatial feature.

The method may further comprise normalising said candidate spatial features based on at least one of: travel time, speed of movement, distance, starting position, end position, a turning point; and a floor change point or region. The parameters may be included in or else derivable from the positioning data (in which case the method may further comprise processing the collected and/or stored positioning data to compute the relevant parameters). Normalisation steps performed prior to correlation may include: rotation and scaling of features; splitting positioning data which relates to relatively long journeys into smaller data portions relating to shorter journeys (for example if a user walks through a floor of a shopping centre, the normalisation algorithm may split the data relating to the entire journey into smaller paths between pairs of nodes prior to correlation); combining positioning data which relates to a plurality of relatively shorter journeys to form a larger data portion relating to a longer journey (for example if a user walks through a plurality of shorter paths in the same floor of a shopping centre, the normalisation algorithm may combine the data relating to the shorter journeys between nodes into a longer path prior to correlation); using the signal measurement profile (or captured images, sonic depth/distance measurements, and so on) to normalise said candidate spatial features, e.g. using the signal profile (or captured images, sonic depth/distance measurements, and so on) to identify shorter paths between nodes from collected data relating to a longer journey. The signal measurement profile (and/or captured images, sonic depth/distance measurements, and so on) may be used to identify common start and end points of paths (e.g. to identify common start and end points of one or more relatively shorter journeys from positioning data relating to longer journeys, or to identify common start and end points of a relatively long journey from positioning data relating to a plurality of shorter journeys).

It may be that the candidate spatial features input to the correlation algorithm comprise at least one candidate spatial feature from the said smaller data portions relating to shorter journeys (derived by splitting positioning data which relates to relatively long journeys). It may be that the candidate spatial features input to the correlation algorithm comprise at least one candidate spatial feature from a said larger portion relating to a longer journey (derived by combining positioning data which relates to relatively shorter journeys).

Accordingly, it may be that the method further comprises normalising one or more candidate spatial features by one or more of: rotating a said candidate spatial feature; scaling a said candidate spatial feature; splitting positioning data which relates to relatively long journeys into smaller data portions relating to shorter journeys and deriving one or more candidate spatial features from the said smaller data portions; combining positioning data which relates to a plurality of relatively shorter journeys to form a larger data portion relating to a longer journey and deriving one or more candidate spatial features from the said larger data portion; and normalising a said candidate spatial feature in dependence on a signal measurement profile associated with the said candidate spatial feature.

Normalisation typically takes into account whether two or more of the said matching candidate spatial features may have been derived from positioning data relating to one or more mobile devices approaching and/or passing through a spatial feature at different angles and/or from different directions.

The method preferably further comprises generating at least one path estimate in dependence on said at least one candidate spatial feature, and selecting said at least one other spatial feature matching said at least one path estimate. The path estimate is preferably a ‘true’ path estimate.

The method may further comprise determining a quality assessment (such as a covariance matrix or other appropriate measure) for a candidate spatial feature (or in particular each path estimate, or node estimate), and processing said matching spatial features in dependence on said quality assessment.

In more detail, the method may further comprise quality assessing (typically by comparing) one or more (or each of the) possible pairs of candidate spatial features from the said matching candidate spatial features, or quality assessing (typically by comparing) one or more (or each of the) possible pairs of normalised matching candidate spatial features from the said normalised matching candidate spatial features (where provided), to provide one or more quality assessed candidate spatial features (e.g. if candidates of a pair are identical or sufficiently similar it may be that only one quality assessed candidate spatial feature is provided, otherwise typically two quality assessed candidate spatial features are provided per pair), each of the said quality assessed candidate spatial features being associated with one or more quality measures (and typically storing said quality measures and associating the said quality measures with the relevant said quality assessed candidate spatial feature). The method may further comprise: comparing one or more of the said quality assessed candidate spatial features to one or more spatial features from a spatial features database (optionally using the said quality measures associated with the quality assessed candidate spatial features to determine whether the quality assessed candidate spatial features are of greater quality than the spatial features of the spatial features database and, if so, using the said quality assessed candidate spatial feature(s) to update the spatial features database). The method may further comprise combining one or more of the said spatial features from the spatial features database with one or more of the said quality assessed spatial features (e.g. with one or more quality assessed candidate spatial features having one or more quality measures greater than or equal to a corresponding quality measure of the said spatial feature from the spatial features database) to provide a combined spatial feature (e.g. responsive to a determination that the said one or more quality assessed candidate spatial features have one or more quality measures greater than or equal to a corresponding quality measure of the said spatial feature from the spatial features database).

A plurality of said at least one candidate spatial features may correspond to a single (real, underlying, or assumed singular) spatial feature. Said plurality may be individual reported readings or data sets relating to said (singular) spatial feature and/or may represent hypotheses of said (singular) spatial feature. The candidate spatial features may as a whole include an entire set of hypotheses relating to a plurality of different real spatial features (in which case the hypotheses may be evaluated per single underlying/assumed spatial feature, or as a whole—for example, per aforesaid group—or in portions thereof). The aforesaid composite spatial feature may for example be a single hypothesis selected from a plurality of hypotheses. For example, the candidate spatial features may include a plurality of candidate node features having different coordinates (amongst other things) representing hypotheses or estimates of the location of a real node traversed by a user, and likewise for path spatial features. Each hypothesis spatial feature is preferably associated with a quality assessment as aforesaid, preferably in the form of a covariance matrix or other appropriate measure.

Preferably more than one hypothesis is stored in the database or other appropriate storage device, preferably in conjunction with the quality assessment/measure. Accordingly updating the database of spatial features may comprise storing at least one hypothesis of at least one spatial feature (such as a node and the position thereof, and so on). In a process comparable to the grouping of candidate spatial features as aforesaid, the method may further comprise assigning each hypothesis in the database to at least one of a plurality of groups of hypotheses, and each hypothesis may be assigned to a respective one of said groups of hypotheses in dependence on its similarity to other hypotheses in the same group. Similarly, each group may correspond to a geographical sub-division of the region. When the relevant spatial feature is considered at a later time, preferably the hypothesis spatial features are retrieved from the database (for example as the ‘other’ spatial features compared to a new set of candidate spatial features), and the associated quality assessments can be used to reassess previous estimated positions and other attributes with a minimum of processing power. In one embodiment, some of the hypotheses stored in the database are composite spatial features (for example derived from positioning data gathered by different devices, or derived from positioning data from one or more devices over a particular time period, and so on).

The method preferably further comprises processing said matching spatial features in the form of a plurality of node spatial features and at least one path spatial feature, and may comprise (as appropriate) transforming stored spatial features into such elements. Processing said matching spatial features preferably comprises identifying matching node spatial features in said matching spatial features, and combining said matching node spatial features into a single node. The method may further comprise adjusting path spatial features in said matching spatial features to conform to the changed node spatial features. The method may comprise grouping similar spatial features first and processing in groups.

In the case where the database of spatial features includes stored positioning data associated with said at least one other spatial feature, the step of processing said matching features may include processing said stored positioning data. The method preferably further comprises storing at least a portion of the collected positioning data in the database of spatial features.

The method may further comprise updating the spatial features database by storing the combined spatial feature in the spatial features database (e.g. in place of the said spatial feature of the spatial feature database). In more detail, the method may further comprise storing one or more or all of the said (e.g. matching and/or normalised, where provided and/or quality assessed candidate spatial features having a quality measure exceeding a quality threshold) candidate spatial features in a or the spatial features database.

It may be that the positioning data collected by the mobile device comprises one or more or each of the following: an estimated (e.g. current) position of the device; a motion vector representing a (current) direction of travel of the device; and a time reference associated with the estimated (current) position and/or the motion vector. Typically the or each motion vector is associated with an or a respective estimated position of the device. Typically the or each motion vector represents a direction of travel of the device at an or a respective estimated position of the device associated with the said motion vector.

In more detail regarding features mentioned above, the method may comprise dividing one or more or each of the said one or more candidate spatial features and/or one or more of the said matching candidate spatial features and/or one or more of the said normalised matching candidate features and/or one or more of the said quality assessed candidate spatial features into two or more divided (e.g. matching and/or normalised and/or quality assessed as appropriate) candidate spatial features. The method may comprise dividing the said one or more candidate spatial features and/or one or more of the said matching candidate spatial features and/or one or more of the said normalised matching candidate features and/or one or more of the said quality assessed candidate spatial features into two or more nodes (the nodes representing, for example, turning points or floor switching points) and one or more path lines each extending between a respective pair of nodes. The method may comprise: correlating the said nodes to determine one or more matching nodes (e.g. matching nodes which have been determined to relate to the same nodal spatial feature); combining the said matching nodes to provide a combined node; and adjusting the path line(s) extending from the said matching nodes to extend to or from (as appropriate) the said combined node. The method may further comprise: collecting positioning data relating to the said indoor region from the said mobile device in a prior navigation session (e.g. when the said mobile device occupied, passed through or approached the said indoor region); and identifying one or more of the said other candidate spatial features of the indoor region from the positioning data collected in the said prior navigation session.

Preferably the positioning data is received from at least one positioning module associated with at least one mobile device. Preferably the or each mobile device includes more than one positioning module, but at least one of these may not work indoors (or at least with a predetermined average level of accuracy, and so on). It is preferably processed at least in part on the or each same mobile device. The method may further comprise synchronizing with another device (which may be a server, controller or other centralized element), wholly or in part, at least one of: the collected positioning data, said at least one candidate spatial feature, and said at least one other spatial feature. The method may further comprise accessing the database of spatial features to assist a location service for a mobile device (for example by providing data from the spatial features database to a location server, or alternatively to provide a location service directly based on the same data).

In more detail, the method may further comprise: collecting positioning data from a second mobile device (e.g. over a navigation session) relating to (e.g. the second mobile device occupying, moving through or towards) the indoor region, the second mobile device being a different mobile device (albeit they may be of the same type) from the said (first) mobile device; and identifying one or more of the said other candidate spatial features of the indoor region from the positioning data collected by the second mobile device.

In yet more detail regarding the controller mentioned above, the method may further comprise: the mobile user device providing the identified candidate spatial features to the controller (e.g. provided on one or more servers); and the controller correlating the said one or more candidate spatial features with one or more other candidate spatial features from a or the spatial features database to determine two or more matching candidate spatial features (i.e. candidate spatial features which have been determined to relate to the same spatial feature of the indoor region). The method may comprise the controller normalising the said matching candidate spatial features. The method may further comprise the controller quality assessing (typically by comparing) one or more (or each of the) possible pairs of the said matching candidate spatial features to provide one or more quality assessed candidate spatial features, each of the said quality assessed candidate spatial features being associated with one or more quality measures. The method may further comprise the controller combining one or more of the said spatial features from the spatial features database with one or more of the said quality assessed spatial features (e.g. with one or more quality assessed candidate spatial features having one or more quality measures greater than or equal to a corresponding quality measure of the said spatial feature from the spatial features database) to provide a combined spatial feature (e.g. responsive to a determination that the said one or more quality assessed candidate spatial features have one or more quality measures greater than or equal to a corresponding quality measure of the said spatial feature from the spatial features database). The method may further comprise the controller updating the spatial features database by storing the combined spatial feature in the spatial features database (e.g. in place of the said spatial feature of the spatial feature database). The method may further comprise the controller transmitting at least an updated portion of the spatial features database to the mobile device.

In another aspect of the invention there is provided a data processing system (for example a singular device, a more general data processing apparatus or interlinked apparatus) including (at least one) processor and (at least one) associated memory, said data processing system being operable to update a database of spatial features, said spatial features being associated with a region, and said data processing system being programmed to perform a method of: receiving positioning data that has been collected at a plurality of locations within the region; processing the collected positioning data to identify at least one candidate spatial feature associated with the region; identifying at least one other spatial feature corresponding to said at least one candidate spatial feature, said at least one other spatial feature and said at least one candidate spatial feature as a whole constituting matching spatial features; processing said matching spatial features; and updating the database of spatial features in dependence on the processing of said matching spatial features.

In a further aspect of the invention there is provided a non-transitory computer readable carrier storing computer program code for causing a data processing system (for example a singular device, a more general data processing apparatus or interlinked apparatus) to update a database of spatial features, said spatial features being associated with a region, said data processing system including (at least one) processor and (at least one) associated memory, and the computer program code, when stored in said memory and executed by said processor, causing said data processing system to perform a method of: receiving positioning data that has been collected at a plurality of locations within the region; processing the collected positioning data to identify at least one candidate spatial feature associated with the region; identifying at least one other spatial feature corresponding to said at least one candidate spatial feature, said at least one other spatial feature and said at least one candidate spatial feature as a whole constituting matching spatial features; processing said matching spatial features; and updating the database of spatial features in dependence on the processing of said matching spatial features.

The invention may further extend to data processing apparatus (or system) comprising a collection module programmed to collect positioning data from a mobile device (for example over a navigation session) relating to (for example the mobile device occupying, moving through or towards) an indoor region; a spatial feature identification module programmed to identify one or more candidate spatial features of the indoor region from the collected positioning data; and a correlation module programmed to correlate the said one or more candidate spatial features with one or more other candidate spatial features (for example which may be provided in a local pool of spatial feature data stored on the mobile device or a central pool of spatial feature data stored on one or more servers in data communication with the mobile device) to determine two or more matching candidate spatial features (that is, candidate spatial features which have been determined to relate to the same spatial feature of the indoor region).

In a yet further, related, aspect of the invention, there is provided a method of updating a database of spatial features, said spatial features being associated with a region, and the method comprising: receiving positioning data that has been collected at a plurality of locations within the region; processing the collected positioning data to identify at least one group of candidate spatial features (such as paths and nodes) associated with the region; for each group: accessing the database to identify at least one stored spatial feature corresponding to the respective candidate spatial features in the group, said at least one stored spatial feature and said respective candidate spatial features constituting matching spatial features, processing said matching spatial features, and updating the database of spatial features in dependence on the processing of said matching spatial features. Identifying may comprise selecting or generating, as appropriate.

The invention may further extend to a method for autonomous indoor spatial features crowd-sourcing comprising the following steps:

a. Aggregating position data over one navigation session;

b. Pre-processing the aggregated set of points to generate a rough estimation of spatial features in form of path lines and nodes;

c. Post processing a group of rough estimations of spatial features to generate multiple true path(s) estimations associated with quality measures;

d. Comparing the new estimations to the best matches in an existing spatial features database;

e. Combining existing and new estimations of spatial features to improve the quality of spatial features in the database; and

f. Updating the database with the combined version and all possible estimations.

Various aspects of the invention described herein may relate to the detection of estimates of position or characteristics of movement of mobile devices (such as mobile phones) from (typically radio frequency) electromagnetic signals detected from (typically radio frequency) electromagnetic signal sources (e.g. terrestrial electromagnetic signal sources such as Wi-fi access points, Bluetooth® beacons and the like) using positioning data. Positioning data can be stored as a database of positioning data on a tangible computer readable medium (for example one or more memories). Typical positioning data include identifiers of electromagnetic signals sources (e.g. MAC IDs), and the position (estimated or measured) of electromagnetic signal sources (at least some of which are typically indoors). Databases of positioning data may include the strength of signals from electromagnetic signal sources, or other data from which the strength of signals from the electromagnetic signal sources can be deduced. This positioning data enables mobile user devices to determine their position from the measured strength of signals from electromagnetic signal sources, for example by triangulation. Some databases of positioning data include the strength of signals from electromagnetic signals sources at different locations instead of, or in addition to, the location of the electromagnetic sources. Again, the position of a mobile user device can be determined from the measured strength of signals from electromagnetic signal sources, for example by interpolation.

The invention, in any aspect, may relate to databases of positioning data for use by mobile user devices to estimate their position more accurately. Further relevant information can be found in U.S. Pat. No. 8,634,359, International Patent Applications WO 2011/077166, WO 2010/052496, WO 2013/041885, WO 2013/054144, WO 2013/041889, WO 2013/108043, WO 2013/171465, WO 2014/006423, WO 2014/016602, WO 2014/091249, U.S. patent application Ser. No. 13/923,864 and U.S. provisional Patent Application 62/037,236, each of which is hereby incorporated by reference.

The invention provides a method for creating a database of geographical spatial features by post processing data submitted by a plurality (e.g. crowd) of users (typically carrying mobile user devices) approaching an indoor area, e.g. from different angles and/or walking in different directions. The method typically involves aggregating inputs from all of the said users to form a pool of geographical spatial features; and processing the pool of geographical spatial features to generate core database entries.

Another aspect of this invention is to maintain a or the database of geographical spatial features and improve it by post processing further data sourced through the said plurality of mobile user devices. To support this adaptive nature of the geographical spatial feature database, the method also involve a means of splitting, or normalizing, a spatial feature, such as corridor, into multiple simplified spatial features, such as lines and turning points, to support partial correlation with any new data streamed into the pool.

A further aspect of this invention is to support aggregation of geographical spatial features in a local database versus the centralized database. This involves means of synchronizing local and central databases applying the same steps of normalization and correlation used in maintaining the database.

The method further extends to data processing apparatus for performing any method aspect of the invention as aforesaid.

Optional or essential features described above in respect of any one of the various aspects of the invention are at least optional features of any of the aspects of the invention.

Although various aspects and embodiments of the present invention have been described separately above, any of the aspects and features of the present invention can be used in conjunction with any other aspect, embodiment or feature where appropriate. For example apparatus features may where appropriate be interchanged with method features. References to single entities should, where appropriate, be considered generally applicable to multiple entities and vice versa. Unless otherwise stated herein, no feature described herein should be considered to be incompatible with any other, unless such a combination is clearly and inherently incompatible. Accordingly, it should generally be envisaged that each and every separate feature disclosed in the introduction, description and drawings is combinable in any appropriate way with any other unless (as noted above) explicitly or clearly incompatible.

### DESCRIPTION OF THE DRAWINGS

An example embodiment of the present invention will now be illustrated with reference to the following figures in which:

FIG. 1 is a table of typical positioning data;

FIG. 2 is a flowchart of a method of updating a database of spatial features;

FIG. 3 is a flowchart showing the method of FIG. 2 in more detail;

FIG. 4 is a flowchart showing the pre-processing step of FIG. 3 in more detail;

FIG. 5 is a flowchart of a method of synchronising spatial features updated in accordance with the method of FIG. 2;

FIG. 6 is a schematic of a device for use with the method of FIG. 2;

FIG. 7 is a schematic of a central controller for use with the method of FIG. 5;

FIG. 8 is a schematic of a first embodiment of a system in accordance with the method of FIG. 2;

FIG. 9 is a schematic of a second embodiment of a system in accordance with the method of FIG. 2;

FIG. 10 is a schematic of a third embodiment of a system in accordance with the method of FIG. 2;

FIGS. 11a and 11b are example floor plans from a building showing an example navigation path through the building;

FIGS. 12a and 12b are a plan view and isometric view of the example navigation path of FIGS. 11a and 11b;

FIGS. 13a and 13b are illustrations of the decomposition of the navigation path of FIGS. 12a and 12b into different groups of spatial features;

FIGS. 14a and 14b are illustrations of the simplification of the groups of FIG. 13b into separate spatial features;

FIG. 15 is an illustration of a stored path relating to the building of FIGS. 11a and 11b;

FIG. 16 is an illustration of the simplification of the stored path of FIG. 15 into separate spatial features;

FIGS. 17a and 17b illustrate the combination of multiple estimated nodes into a single node;

FIG. 18 illustrates a composite path formed by combining nodes according to the process shown in FIGS. 17a and 17b;

FIGS. 19a and 19b illustrate the decomposition of the composite path of FIG. 18 into a minimum number of true paths;

FIGS. 20a, 20b and 20c illustrate the decomposition of the composite path of FIG. 18 into a minimum number of non-overlapping true paths; and

FIGS. 21a and 21b illustrate the use of electromagnetic signals profiles in an embodiment of the method of FIG. 2.

### DETAILED DESCRIPTION OF AN EXAMPLE EMBODIMENT

One real life example of indoor spatial features crowd-sourcing involves a navigation session relating to step by step navigation points followed by a mobile user carrying a smart phone. For every navigation session, the phone would store all coordinates associated with universal time stamps and the correlated motion vector. The motion vector is an estimation of pedestrian movement as distance and bearing from the last coordinates.

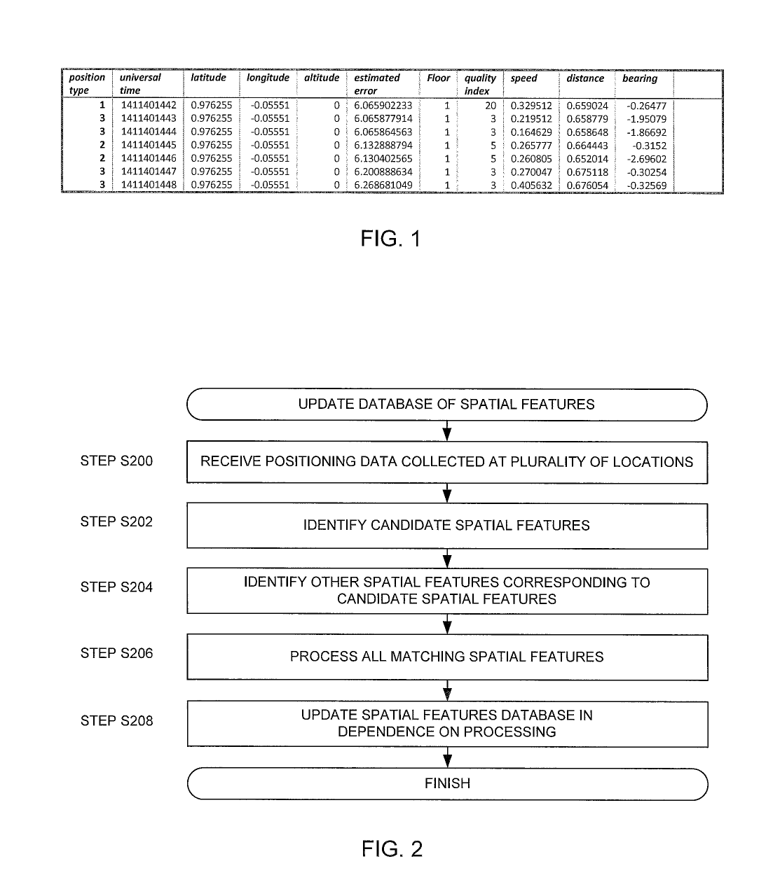

The table of FIG. 1 provides an example of input data, where
Position type: represents the method used in obtaining the coordinates;
Universal time: UTC time in Unix format;
Lat/Ing/alt: The 3D coordinates defining the location of the phone at this time;
Estimated error: An indication of possible error in meters;
Floor: An indication to the floor number in multi-storey building if applicable;
Quality Index: An indication to the confidence in the data and the quality of the information sources such as GPS, WiFi, Bluetooth®, Accelerometer and digital compass;
Speed: an estimation of the walking or movement speed in meter per second;
Distance: An estimation of how many meters the phone moved since last entry; and
Bearing: An estimation of the phone bearing, movement direction, during this time.

Once the user decides to end the navigation session, the input data mentioned above will be pre-processed and inserted into the pool of spatial features. This initial pre-processing comprises one or more or all of the following steps:
Split the data into floors and generate one more floor changing spatial feature as a polygon containing consecutive data points with different floor values;
Streaming each group of floor data into a filter to identify the turning points coordinates as a polygon containing consecutive data points with bearing exceeding the filter threshold; and
Process every set of data points between (every) consecutive turning points to generate a path line in a form of a line or arc associated with two references to either turning points polygons or floor changing polygons or combination of both.

As a result of processing the input data for one navigation session, a set of spatial features will be added to a local or central pool of spatial features.

The next step comprises post processing all the data in the pool to update the spatial features database. The post processing method comprises one or more or all of the following steps:
Initial correlation check of all data in pool to group them into multiple matches;
For each group:
   Perform a normalization based on travel time, speed and distance and modify the start point, end point as well as any turning points or floor changing points;
   Feed all possibilities into a spatial filter that will output multiple estimations of a true path, each associated with time stamp, statistical measures and uncertainty values;
   Fetch from the spatial database all possible matches to the estimated true path;
   Break all estimated true path into path lines and nodes (nodes being turning points or floor switching points);
   Combine every matching group of nodes into one node and adjust the path lines to follow the combined nodes;
   Update the spatial features database with the combined nodes, path lines and the new ones with no matches.

If the spatial features database is hosted locally, or shared between limited numbers of mobile devices, the method may also involve a step of synchronizing these data to a central database where it can be shared with larger number of users or mobile devices.

The synchronization process may comprise one or more or all of the following steps:
Select from the local database all spatial features that have been updated after the last synchronization run;
Send the selected data to the central controller over any means of data transferring;
On receiving the data the controller fetches from the central database all possible matching features;
Run every matching pair into combining filter (same steps as post processing method described above) in respect to the time stamp, statistical measures and uncertainty values;
Update the central database
Send the updates to the local controller to update the local database.

The spatial features may comprise any of the following or any other suitable spatial features: areas (or spaces) within the indoor region (such as rooms or corridors), linear features (e.g. walls), gaps in features (e.g. portals such as doors), floor-change features such as elevators, escalators or staircases, turning points, ends of corridors and so on.

The methods and systems mentioned above will now be described in more detail, with reference to FIGS. 2 to 20.

FIG. 2 is a flowchart of a method of updating a database of spatial features according to one embodiment.

In step S200 positioning data, collected at a plurality of locations, is received. The data may be in the form of the data shown in FIG. 1, for example. The positioning data is typically compiled by one or more mobile devices, each having one or more positioning modules including Global Navigation Satellite Systems (GNSS), Wi-Fi rangefinder systems, pedometer dead reckoning (PDR) systems, and so on, though typically the areas of interest are indoors and therefore the available data is a mixture of low accuracy absolute positioning data (for example from the Wi-Fi rangefinding) and low- to high-accuracy relative positioning data (from the PDR systems, for example).

In Step S202 candidate spatial features are identified, as explained in more detail below (and above). In Step S204, other spatial features (for example from a pool of features or from the same or a further spatial features database) corresponding to the candidate spatial features are identified, both sets of features together constituting ‘matching spatial features’. The database of spatial features may be a local or remote database, for example used by a positioning service. In step S206, all the matching spatial features are processed, typically to create improved estimates of spatial features, and the spatial features database is updated (S208) as a consequence of the processing, typically by storing (at least) the improved estimates.

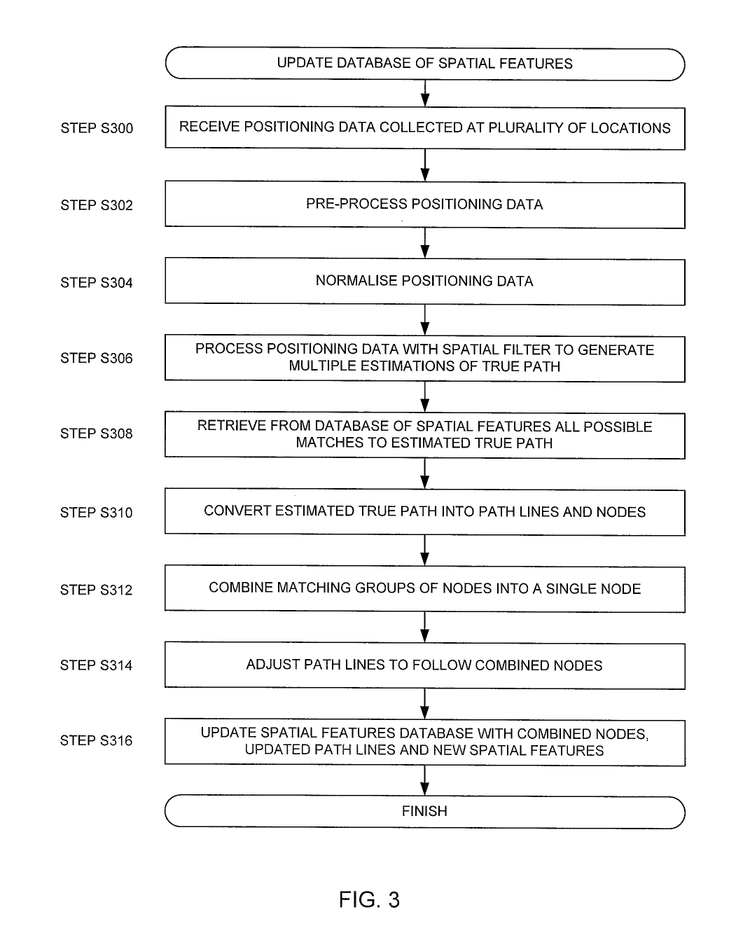

FIG. 3 is a flowchart showing the method of FIG. 2 in more detail. The flowchart covers the updating of existing features in a spatial features database. However, with appropriate modification (for example to step S308 below, if it refers instead to spatial features within a pool of collected data, rather than to data in an existing spatial features database) a method of creating new entries in the database is described.

In step S300, positioning data is received as before. In step S302, the positioning data is pre-processed, as will be explained below. While beneficial, this step can be omitted if necessary and/or appropriate.

In step S304 the positioning data is normalised. The positioning data is adjusted to take into account factors such as travel time, speed and distance, with start point, end points and any relevant turning points and floor-changing points being modified as necessary as a consequence. While beneficial, this step can be omitted if necessary and/or appropriate.

In step S306, the (if appropriate, pre-processed and normalised) positioning data is processed with a spatial filter to generate multiple estimations of ‘true’ path. As part of Step S306 (or otherwise), a quality measure (or multiple measures) may be applied to the generated estimates, based for example on the type of positioning and any other relevant factors.

In step S308, all possible matches to the estimated true path(s) are retrieved from the database of spatial features. The matches may be limited by any appropriate means, for example geographically limited, or limited to a particular number or quality of match. As mentioned above, the described process may be adapted, by search a raw pool of collected spatial features data (rather than an existing spatial features database) to create new data in a spatial features database. Where appropriate, references herein to selecting from a spatial feature database (and/or updating existing data in the database) can be applied alternatively or additionally to selecting from a different (local or other) pool of collected spatial features data (and/or creating new data in the database).

In step S310 the estimated true path(s), including the candidate true path(s) generated by the spatial filter and the true path(s) retrieved from the database are converted into path lines and nodes. (The processing of the candidate and stored spatial features may as appropriate be divided into separate processing steps at different times.)

In step S312 matching nodes are grouped into a single node. Nodes which do not match any other may result in new spatial features being generated. In step S314 path lines are adjusted to conform to the amended nodes. In step S316, the spatial features database is updated with the combined nodes and updated path lines, any new spatial features arising from the processing in step S314, and (optionally, though usefully) additional positioning data used to create the new estimates, so that subsequent processing steps can take the positioning data into account when creating estimates, and so on.

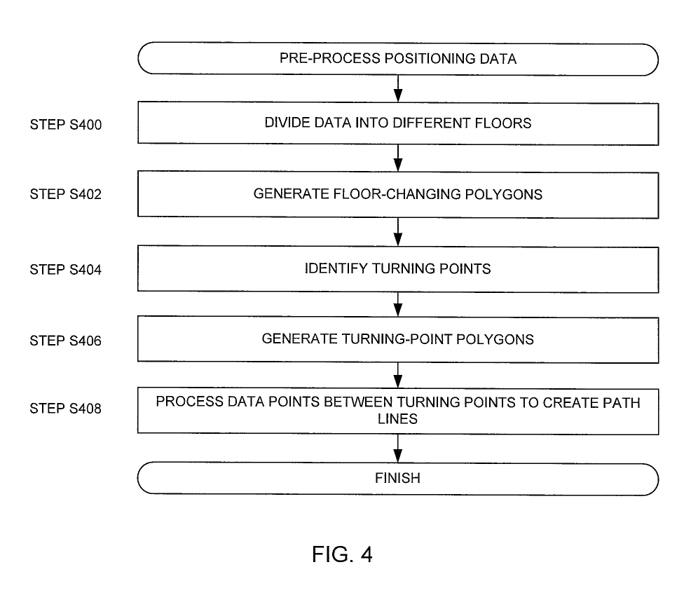

FIG. 4 is a flowchart showing the pre-processing step of FIG. 3 in more detail.

In step S400, the data is divided into different floors (or other geographical regions/sub-regions, as appropriate, including divisions within the same floor or vertical height). In step S402, floor-changing spatial features are converted into polygons (‘floor-changing polygons’) containing consecutive data points with different floor values, although other data structures and formats are of course possible.

In step S404, each group of floor data is processed by a filter (or other appropriate means) to identify turning points, and in step S406 ‘turning-point polygons’ are generated, consisting of polygons containing consecutive data points with bearing exceeding a relevant threshold.

In step S408 every set of data points between consecutive turning points are processed to generate path lines in the form of a line or arc, and each path line is associated with two references, each reference being either to a turning-point polygon or a floor-changing polygon.

Thus, the positioning data has been simplified into a floor-changing spatial features, turning-point spatial features, and a series of paths linking them together.

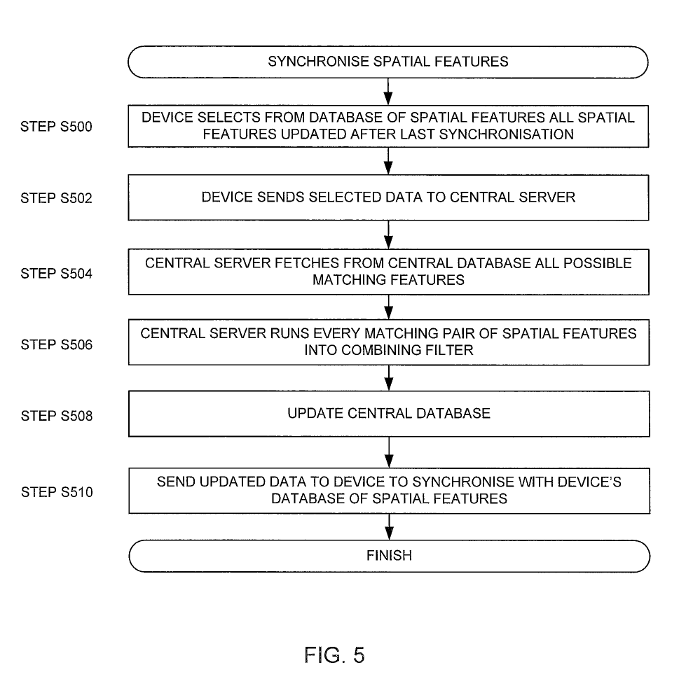

FIG. 5 is a flowchart of a method of synchronising spatial features updated in accordance with the method of FIG. 2. This synchronising method relates to a particular embodiment (see below) in which at least one device carries out local processing and storage, and a central controller maintains a central registry of spatial features data, and the two carry out a synchronisation process to ensure that both data stores are up to date. The synchronising method may be executed at any appropriate moment, either on demand by a user, in accordance with a schedule, after a certain amount of data has been updated, acquired or processed, or on request from the central controller, for example.

In step S500, a local device (having its own local spatial features database) selects from its spatial features database all spatial features which have been updated after the last synchronisation process. In step S502, the device sends the selected data to a central server/controller. In step S504, the central server fetches from its own central spatial features database all possible spatial features matching the spatial features data received from the device. In Step S506, the central server runs every matching pair of spatial features into a combining filter, mirroring the processing carried out at the local device (including steps shown in FIG. 3 and described above, for example). The central database is then updated. Because the central server may have received additional data from other devices, or may apply different (for example more sophisticated) processing, the result of the processing may differ from that carried out originally at the device. Accordingly, in step S510, any updated data (with reference to what is known or inferred to be stored at the device, which may for the reasons mentioned above go beyond the data modified in step S508) is sent back to the device. The device then inserts the data received from the central server into its local spatial features database, but in a variant of the present embodiment the local device may as appropriate reprocess the data received from the central server before updating its own database (for example if new data has been received in the meantime).

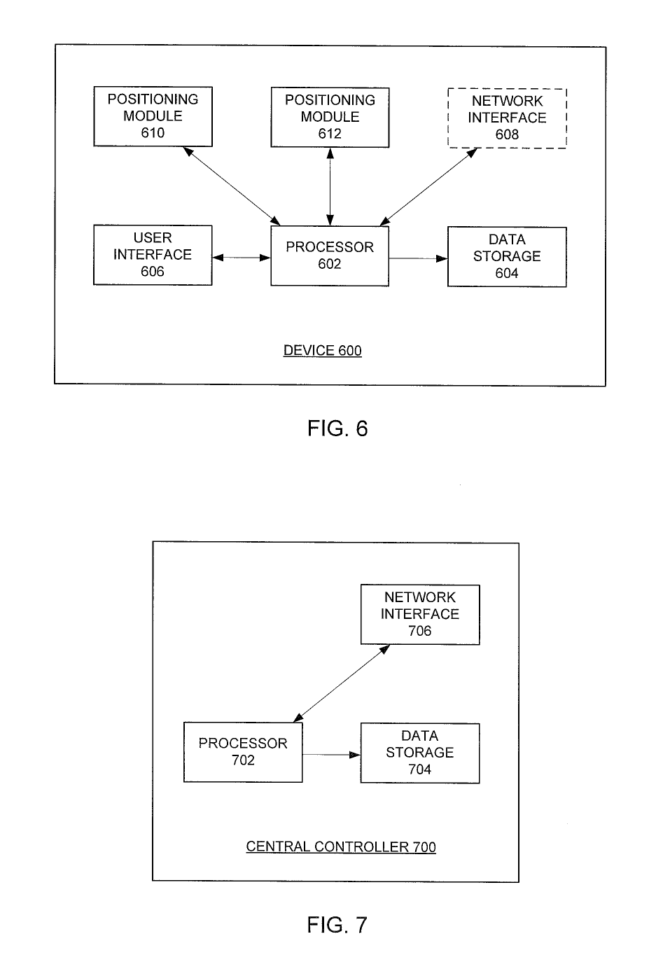

FIG. 6 is a schematic of a device for use with the method of FIG. 2. The device 600, which may be a handheld, mobile or other device, contains a processor 602, data storage 604 (which may include the above-mentioned local database of spatial features), (optional) user interface 606, (optional) network (or other communications) interface 608, and one or more positioning modules 610, 612.

FIG. 7 is a schematic of an optional central controller for use with the method of FIG. 5. The central controller contains, for example, a processor 702, data storage 704 (which may include the above-mentioned central database of spatial features) and network interface 706.

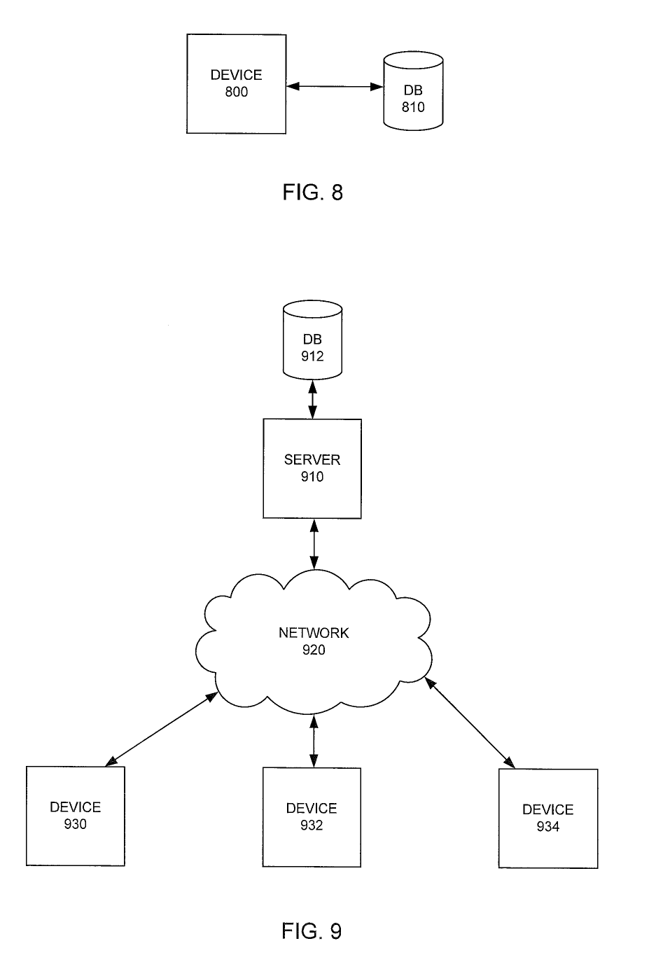

FIG. 8 is a schematic of a first embodiment of a system in accordance with the method of FIG. 2. In this embodiment, a single device 800 is provided, with a corresponding database 810 of spatial features.

FIG. 9 is a schematic of a second embodiment of a system in accordance with the method of FIG. 2. In this embodiment, a central server/controller 910 has an associated database of spatial features 912, connected to a plurality of devices 930, 932, 934 via a network 920 or other communications link. The devices are typically autonomous (for example handheld devices such as smartphones) but do not contain a local spatial features database (though they may have local caches of various sorts). In one mode of operation, the devices 930, 932, 934 used the server 910 as a database server, carrying out spatial features processing locally but using the server database 912 as a repository of the data. In another mode of operation, the processing is carried out partly or wholly at the server 910, which receives positioning data from the devices 930, 932, 934 and transmits back further positioning data, such as an estimated current position of the relevant device, for example.

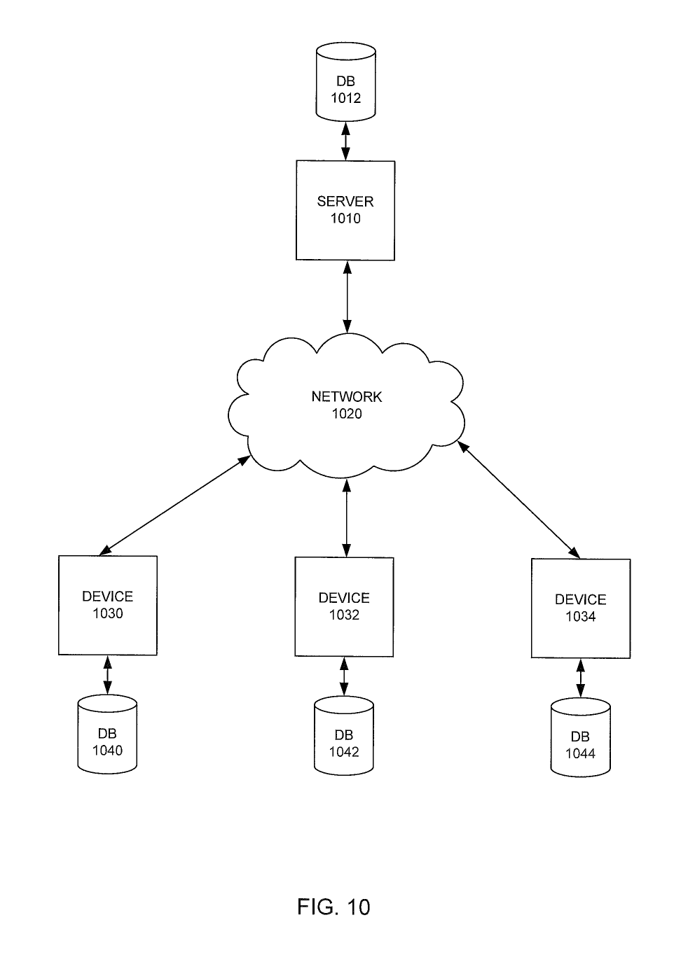

FIG. 10 is a schematic of a third embodiment of a system in accordance with the method of FIG. 2. In this embodiment, a central server 1010 as before is associated with a central repository (database) 1012 of spatial features, and in communication with a plurality of devices 1030, 1032, 1034 via a network (or other communications link) 1020. In this embodiment, however, each device 1030, 1032, 1034 is associated with its own local database 1040, 1042, 1044 of spatial features. A method identical to, or similar to, that described above in relation to FIG. 5 is used to synchronise data across all the databases 1012, 1040, 1042, 1044. Other arrangements, for example incorporating a mix of the system of FIGS. 9 and 10, are of course possible.

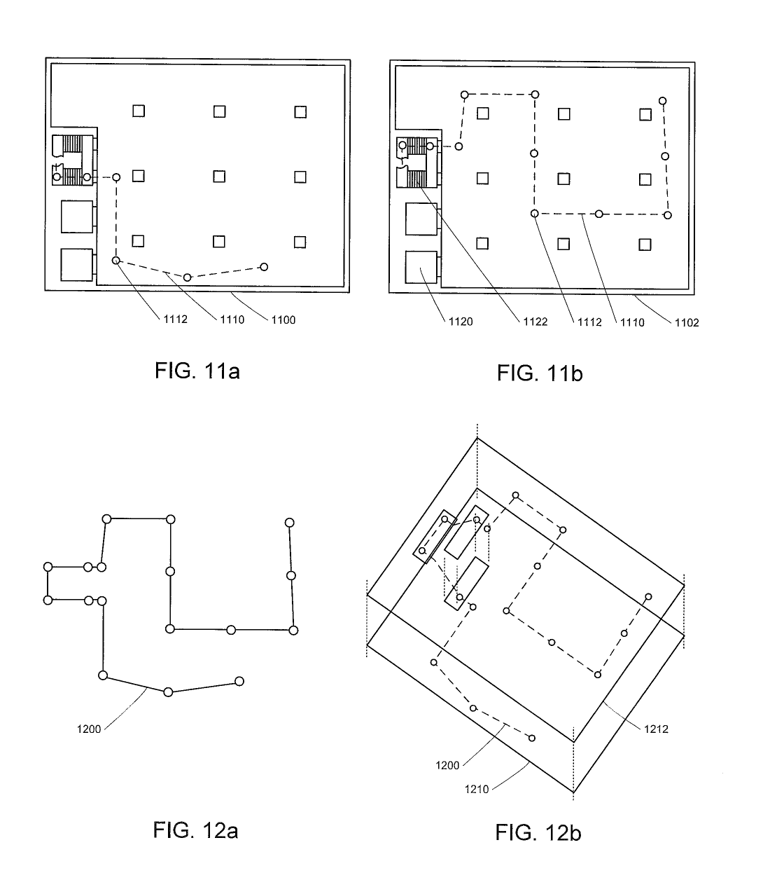

A worked example, representing a simplified and abstracted version of a real life example for the sake of ease of explanation, will now be described with reference to FIGS. 11 to 20.

FIGS. 11a and 11b are example floor plans from a building showing an example navigation path through the building, as might be taken by a user of a mobile device corresponding for example to the device of FIG. 6 in any one of the systems as shown in FIGS. 8 to 10. A lower floor 1100 and a higher floor 1102 are shown, connected by elevators 1120 and a stairwell 1122. The present example relates to consecutive floors, but the same principles may apply, for example, to a journey taken from one floor to another floor several storeys above or below (for example by elevator), or to a journey within one floor or many floors, or in areas limited geographically in other ways (for example in different buildings on the same or on different levels), or wholly or partially outdoors, and so on. The path taken 1110 is shown as a dashed line overlaid on the floor plans, which omit details of offices and so on for simplicity, and is broken in the region of the stairwell 1122, which (like the elevator 1120) constitutes a floor-changing zone as described above. Data (or sampling) points, corresponding to locations where positioning data is collected from at least one positioning module associated with the device, are shown with small solid circles 1112. For ease of illustration, the ‘true path’ taken by a user of the device is shown. In a real life example, there may be more or fewer data points 1112, and the accuracy will typically be lower, especially indoors where a satellite signal is not available for use with GNSS systems. Examples of these inaccuracies, and systems for compensating for them and providing appropriate estimates and quality indices are given in the co-pending applications referred to above.

FIGS. 12a and 12b are a plan view and isometric view of the example navigation path of FIGS. 11a and 11b. Here the unbroken (true) navigation path 1200 is shown, as well as planes 1210, 1212 representing the two different floors. The landings of the stairwell area are also shown for ease of interpretation.

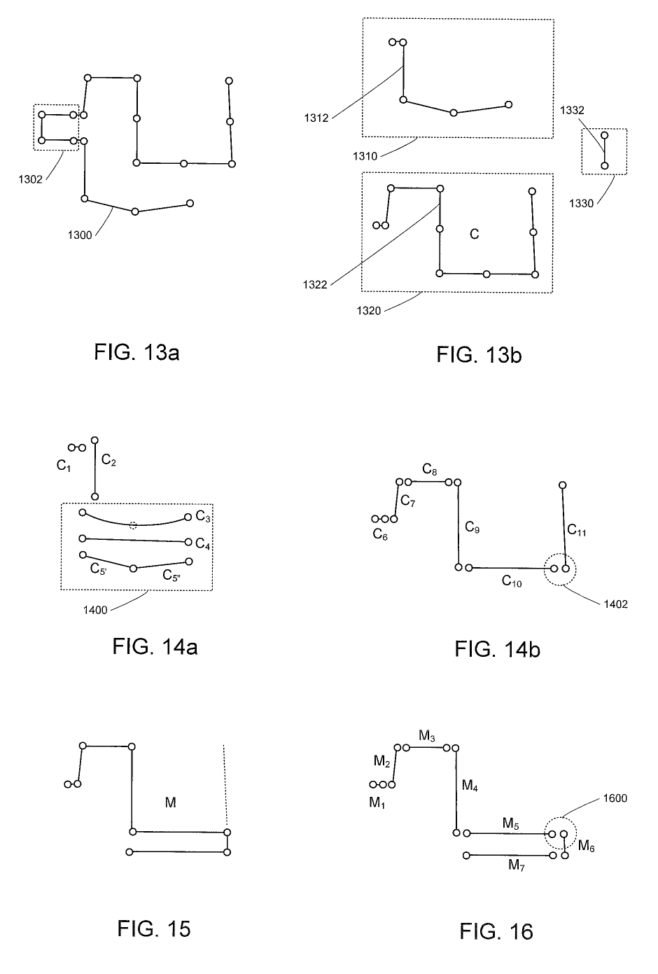

FIGS. 13a and 13b are illustrations of the decomposition of the navigation path of FIGS. 12a and 12b into different groups of spatial features. FIG. 13a shows a region 1302 of the navigation path 1300 which is assessed (from prior processing and/or by consideration of the positioning data, e.g. the height) as relating to a floor-changing spatial feature. The navigation path is decomposed into two groups 1310, 1320 corresponding to navigation paths 1312, 1322 within two different floors. The portion of the navigation path relating to the floor-changing spatial feature is simplified, as described above, into a polygon 1332 having one data point per floor. The path 1312 corresponds to the navigation path taken on the lower floor, and the path 1322 corresponds to the navigation path taken on the upper floor.

FIGS. 14a and 14b are illustrations of the simplification of the groups of FIG. 13b into separate ‘candidate’ (C) spatial features. Here, the two paths 1312, 1322 of FIG. 13b are divided into nodes and ‘simple’ paths C₁ to C₁₁, which are shown in exploded form for ease of explanation. The path 1312 on the lower floor is decomposed into path C₁, C₂ and a variety of paths C₃, C₄, C_{5′} and C_{5″} corresponding to different true path estimations 1400 of the same element of the path 1312. In more detail, the true path estimates 1400 include one solution C₃ with two nodes joined by one arcing path (passing through the data point shown with a dashed line, which has been eliminated as part of the process), one solution C₄ with two nodes joined by one straight path, and a further solution C_{5′}, C_{5″} with three nodes (corresponding essentially to the original data points) and two straight paths inbetween. Each of the solutions C₃, C₄, C_{5′}, C_{5″} is attributed a quality measure indicating the quality of the estimate. In a real world example there may be more solutions outputted than as shown in FIGS. 14a and 14b; the set of solutions 1400 are merely indicative.

The navigation path 1322 from FIG. 13b of the upper floor is decomposed in this example more simply into elements C₆, C₇, C₈, C₉, C₁₀, C₁₁, again shown in exploded form in FIG. 14b for ease of illustration. The nodes shown at intersection 1402 will be discussed further below by way of an example of the processing method described above. In FIG. 14b, various data points have been eliminated because they failed to meet the threshold for a turning point, for example because the change in bearing was below a threshold (or, put another way, the angle subtended at the intersection did not fall sufficiently below 180 degrees to be considered to represent a substantial change in direction).

As a result of the processing illustrated in FIGS. 13 and 14, it will be appreciated that the number of data points has been reduced, and the structure of the spatial features greatly simplified.

FIG. 15 is an illustration of a stored path relating to the building of FIGS. 11a and 11b, and in particular relating to the lower floor and navigation path 1322 of FIG. 13b. The path is a model (M) of spatial features, and may be stored and/or defined in any appropriate way. In this example the model M defines a particular path through the floor in question. The deviation of the navigated path 1322 from the model path M is illustrated with a dotted line.

FIG. 16 is an illustration of the simplification of the stored path of FIG. 15 into separate spatial features M₁ to M₇. The process corresponds essentially to that undertaken in FIGS. 14a and 14b. As a result of the process, the model path M is simplified into simple nodes and paths, for ease of comparison with and joint processing with the candidate spatial features in FIGS. 14a and 14b. In one embodiment, spatial features are stored in the database in the form shown in FIG. 16, obviating the need for the present step of processing. The nodes shown at 1600 coincide approximately (geographically) to the nodes shown at 1402 in FIG. 14b.

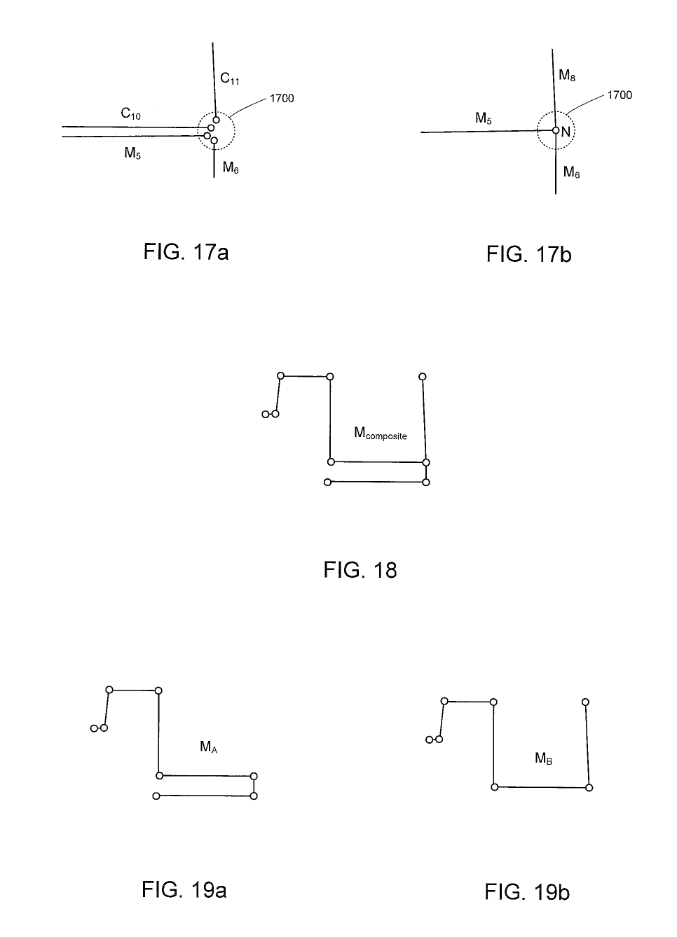

FIGS. 17a and 17b illustrate the combination of multiple estimated nodes into a single node N. When the data derived from the model path M is combined with the data derived from the navigation path (in accordance with the method described above), the paths C₁₀, C₁₁, M₅, M₆ meet approximately within the area 1700 corresponding to the areas 1402 and 1600 above. As part of the node combining process mentioned earlier, the estimates for the four nodes are combined to form a single node N. The weighting/quality indices associated with the four nodes are taken into account, so that the node N is not necessarily at the geographical centre of the pre-combined nodes. After the node combination, paths are adjusted to conform to the adjusted node positions and the data is simplified. FIG. 17b shows pre-existing path elements M₅, M₆ and a new path element M₈ derived from the (new) positioning data.

FIG. 18 illustrates a composite path formed by combining nodes according to the process shown in FIGS. 17a and 17b. This shows the effect of combining the path elements M₁ to M₈ resulting from the node combining and re-pathing process mentioned above. The path elements will normally need to be further processed in an appropriate fashion in order to update the database of spatial features.

FIGS. 19a and 19b illustrate the decomposition of the composite path of FIG. 18 into a minimum number of true paths. Here, paths M_{A} and M_{B} represent all possible traversals of the composite path in FIG. 18.

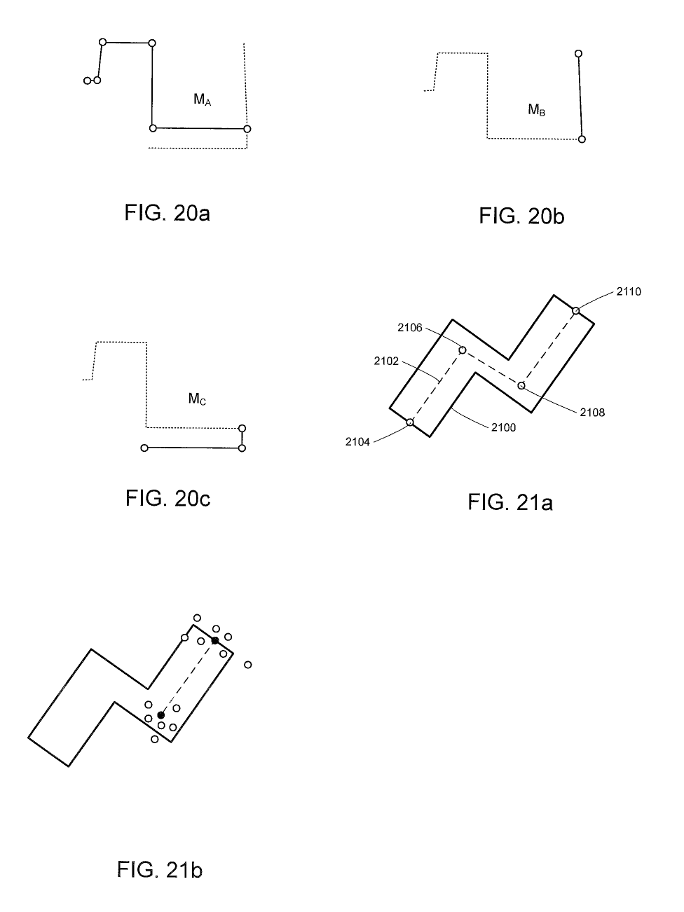

FIGS. 20a, 20b and 20c illustrate the decomposition of the composite path of FIG. 18 into a minimum number of non-overlapping true paths. Here, paths M_{A}, M_{B} and M_{C} can be reassembled to form the composite path in FIG. 18. This form of spatial features can have benefits for path-finding, for example, but any appropriate storage format can be used.

FIGS. 21a and 21b illustrate the use of electromagnetic signal profiles in an embodiment of the method of FIG. 2.

In this embodiment (as also in embodiments described above) the spatial features processing system detects sudden changes in GPS quality metrics to flag an entrance (or exit) and any major change in heading.

Away from entrances and exits, typically the positioning data received from different mobile devices following a particular path between two nodes (or the same device retracing the same route) is not identical, for example if two or more mobile devices collecting PDR (pedometer dead reckoning) positioning data are oriented differently from each other (if they were in a pocket, in a hand, in a calling position, and so on). In these cases, the direction reported by the compass (and therefore the estimated positions along the path or at the nodes) will look very different in each case. Due to these differences in the collected positioning data, positioning data which relates to the same spatial feature (such as a node or a path) may not be correctly correlated (that is, the correlation algorithm may not in the first instance correctly determine that the positioning data relates to the same spatial feature).

To assist with this problem, an electromagnetic signal profile (for example, relating to Bluetooth® and/or Wifi signals received by the mobile device as it follows the path in question) can be generated in respect of each candidate spatial feature which is taken into account during the correlation stage (that is, the stage which identifies matching spatial features). Thus, even when the positioning data is not sufficiently similar for the correlation algorithm to identify that it relates to the same spatial feature, the electromagnetic signal profile will provide a secondary indicator which the algorithm can use to determine that the positioning data does indeed relate to the same spatial feature. This can also prevent the identification of false nodes and paths. Ordinarily, the electromagnetic signal profile cannot be used without the positioning data to identify spatial features.

By way of example, FIG. 21a shows an interior space 2100 and a simplified version of the (actual) path 2102 taken through the space by a user participating in the data collection, and the (actual) nodes 2104, 2106, 2108, 2110 through which the simplified path passes, from entry point 2104 to exit point 2110.

As mentioned above, when the received data is processed, each of the reported points (nodes) 2104, 2106, 2108, 2110 is associated with an electromagnetic signals profile and may possibly include other profiles such as magnetic field measure. These profiles are then used for matching all submissions from different users to the same group, if they belong to the same node. One example of an electromagnetic signals profile could be represented as a fingerprint array such as:

{(BSSID, μ_{RSSi}, σ_{RSSi}), . . . }

where BSSID is the identifier of the signal source, μ_{RSSi} is the median of RSSi (received signal strength) values for all submissions that matches this node, and σ_{RSSi} is the standard deviation of RSSi values for all submissions that matches this node.

On the other hand, all position data recorded between two nodes are used to create a path line (the individual portions of line 2102) defined by travel distance and covariance matrix indicating if any transformation had to be made in order to fit the path line between nodes. Similar to the nodes each path line would also hold radio profile and other profiles. An example of path line radio profile is explained below:

{(BSSID, (X, Y), μ_{RSSi}, σ_{RSSi}, RSS0, N), . . . }

where x/y are coordinates of the central propagation point on the path line, usually the point with strongest RSSi; and μ_{RSSi} and σ_{RSSi} are the statistical values for the central propagation point signal strength. This is required when combining multiple submissions or when there is a range of strong signals in one submission. RSS0 and N are the propagation parameters for a particular path loss model (which describes the propagation between the signal source and the path). Different propagation parameters may be specified for either side of the central propagation point on the path (for example first propagation parameters may be specified for where the path extends between first and second nodes, and second propagation parameters for between the central propagation point and the second node).

The profile should have multiple entries for all signal sources which were visible throughout the transit on the relevant path line and might have duplicates if the same WAP was seen in two segregated regions of the same path. The signal profile for a path may have duplicated entries for a particular signal source if, for example, that signal source was visible with a first set of parameters over a first portion of the path, visible with a second set of parameters over a second portion of path, and invisible to the mobile device over a third portion of the path. The electromagnetic signal profiles may take any other suitable form.

As a crowd based solution, each spatial feature would typically have many submissions that will either agree or disagree on certain parameters including location. Therefore, each feature is associated with a quality measure or covariance matrix (see for example the matrix-algebra/covariance-matrix.aspx page at stattrek.com) describing the variance between different submissions of all parameters. An example of such parameters is shown below:

Node (turning point): {Number of valid submissions, Average location error, Average compass error, Distance from entrance, Accuracy}

This matrix is created for each group of submissions sharing a similar radio profile, such as 80% matching WAPs and signal strength. Then the matrix is used to cluster such submissions into multiple hypotheses, mainly based on distance but optionally based on any combination of thresholds. A probability is then assigned to each one. Finally the overall data can be plotted as in FIG. 21b, showing multiple hypothesis (unfilled circles) surrounding the favoured hypothesis or actual values (filled circles) in respect of a single path element (shown in dotted line).

Multiple hypotheses are kept in the database to ensure a smoother switch if further submissions have boosted the probability for any of them. A range of candidates may be selected and tested to determine whether they are over a certain probability threshold, to try and fit combination of multiple features together, such as path lines and nodes. A selected node may be validated against neighbouring path lines, and vice versa.

Typically the correlation stage is performed on a server, but may alternatively be performed by the mobile device or by a device intermediate the mobile device and the server. The types of electromagnetic signal sources being used are typically terrestrial radio-frequency electromagnetic signal sources, such as (but not limited to) Bluetooth® beacons, Wi-Fi access points and 5G (or other) short range mobile towers and/or transceivers (sometimes referred to as ‘nanocells’ or ‘microcells’).

With regard to any of the foregoing embodiments and variants, spatial features may be nested and/or abstracted, such that a floor/storey may be considered a single spatial feature, containing within it sub-features such as portals, corridors, and so on. The spatial features database may include or be associated with a database of electromagnetic signal sources (such as wireless access points, Bluetooth® beacons, mobile phone base stations, and so on) available in the vicinity of the region being modelled, so as to assist in the provision of a mobile device location service.

It will be appreciated that the method described above is also applicable to outdoor regions. Spatial features outdoors may for example include paths, roads, bridges, crossing points, building entrances, and so on. Navigation sessions may partly or wholly extend into outdoor regions. Part of a pre- or post-processing step may include dividing a navigation session into indoor and outdoor portions, for example based on positional data received at a relevant device (for example a poor performance of satellite-based positioning modules, a detection of light levels, or comparison of estimated location with geographical data, and so on). The pre-processing may for example eliminate outdoor portions so as to selectively process only the indoor portions.

Although the present invention has been described above with reference to specific embodiments, it will be apparent to a skilled person in the art that modifications lie within the spirit and scope of the present invention.

1. A method of updating a database of spatial features, said spatial features being associated with a region, and the method comprising:
receiving positioning data that has been collected at a plurality of locations within the region;
processing the collected positioning data to identify at least one candidate spatial feature associated with the region;
identifying at least one other spatial feature corresponding to said at least one candidate spatial feature, said at least one other spatial feature and said at least one candidate spatial feature as a whole constituting matching spatial features;
processing said matching spatial features; and
updating the database of spatial features in dependence on the processing of said matching spatial features.

2. A method according to claim 1, wherein identifying at least one other spatial feature comprises deriving at least one spatial feature from additional positioning data collected within the region.

3. A method according to claim 1, wherein identifying at least one other spatial feature comprises accessing the database to identify within the database at least one stored spatial feature corresponding to said at least one candidate spatial feature.

4. A method according to claim 1, further comprising receiving geographical data relating to a geographical region in the vicinity of the region, and wherein identifying at least one other spatial feature comprises deriving said at least one other spatial feature from the geographical data.

5. A method according to claim 4, wherein processing said matching spatial features comprises comparing the position of said at least one candidate spatial feature with the position of said at least one spatial feature.

6. A method according to claim 4, wherein the geographical data defines at least one spatial feature corresponding to an access point of a building.

7. A method according to claim 4, wherein at least some of said at least one candidate spatial features are inside a building and the geographical data defines at least one spatial feature outside the building.

8. A method according to claim 4, wherein processing said matching spatial features comprises using the geographical data to validate or adjust said matching spatial features.

9. A method according to claim 4, wherein the geographical data includes at least one recorded path, and processing said matching spatial features comprises validating or adjusting said matching spatial features in dependence on said at least one recorded path.

10. A method according to claim 9, further comprising correlating said matching spatial features with at least one position in said at least one recorded path to determine a quality measure associated with said matching spatial features.

11. A method according to claim 10, further comprising revising said matching spatial features in dependence on said at least one position in said at least one recorded path.

12. A method according to claim 1, wherein processing said matching spatial features further comprises generating at least one composite spatial feature in dependence on said matching spatial features, and updating the database of spatial features includes storing said composite spatial feature in the database.

13. A method according to claim 1, further comprising assigning each candidate spatial feature to at least one of a plurality of groups of candidate spatial features.

14. A method according to claim 13, wherein each candidate spatial feature is assigned to a respective one of said groups of candidate spatial features in dependence on its similarity to other candidate spatial features in the same group.

15. A method according to claim 13, wherein each group corresponds to a geographical sub-division of the region.

16. A method according to claim 1, wherein processing the collected positioning data comprises identifying a plurality of said locations as node locations, and generating node spatial features corresponding to said node locations.

17. A method according to claim 16, wherein processing the collected positioning data further comprises identifying locations intermediate node locations as path locations, and generating path spatial features corresponding to said path locations.

18. A method according to claim 17, wherein all path locations intermediate two node locations are transformed into a single path spatial feature.

19. A method according to claim 1, further comprising normalizing the candidate spatial features based on at least one of: travel time, speed of movement, distance, starting position, end position, a turning point; and a floor change point or region.

20. A method according to claim 1, further comprising normalising one or more candidate spatial features by one or more of: rotating a said candidate spatial feature; scaling a said candidate spatial feature; splitting positioning data which relates to relatively long journeys into smaller data portions relating to shorter journeys and deriving one or more candidate spatial features from the said smaller data portions; combining positioning data which relates to a plurality of relatively shorter journeys to form a larger data portion relating to a longer journey and deriving one or more candidate spatial features from the said larger data portion; and normalising a said candidate spatial feature in dependence on a signal measurement profile associated with the said candidate spatial feature.

21. A method according to claim 13, wherein the method further comprises generating at least one path estimate in dependence on said at least one candidate spatial feature, and selecting said at least one other spatial feature matching said at least one path estimate.

22. A method according to claim 1, further comprising determining a quality assessment for each candidate spatial feature, and processing said matching spatial features in dependence on said quality assessment.

23. A method according to claim 1, wherein a plurality of said at least one candidate spatial features correspond to a single spatial feature.

24. A method according to claim 1, wherein updating the database of spatial features comprises storing at least one hypothesis of at least one spatial feature.

25. A method according to claim 24, further comprising assigning each hypothesis in the database to at least one of a plurality of groups of hypotheses.

26. A method according to claim 25, wherein each hypothesis is assigned to a respective one of said groups of hypotheses in dependence on its similarity to other hypotheses in the same group.

27. A method according to claim 25, wherein each group corresponds to a geographical sub-division of the region.

28. A method according to claim 1, wherein a signal measurement profile is associated with each candidate spatial feature.

29. A method according to claim 28, wherein the signal measurement profile includes at least one of: electromagnetic signal strength measurements, identifiers associated with electromagnetic signal sources, environmental mapping, distance measurements, image data, acoustic data, data quality assessments, propagation model parameters, and path loss parameters.

30. A method according to claim 13, wherein the method further comprises processing said matching spatial features in the form of a plurality of node spatial features and at least one path spatial feature.

31. A method according to claim 30, wherein processing said matching spatial features comprises identifying matching node spatial features in said matching spatial features, and combining said matching node spatial features into a single node.

32. A method according to claim 31, further comprising adjusting path spatial features in said matching spatial features to conform to the changed node spatial features.

33. A method according to claim 1, wherein the database of spatial features includes stored positioning data associated with said at least one other spatial feature, and processing said matching features includes processing said stored positioning data.

34. A method according to claim 33, further comprising storing at least a portion of the collected positioning data in the database of spatial features.

35. A method according to claim 1, wherein the positioning data is received from at least one positioning module associated with at least one mobile device.

36. A method according to claim 1, further comprising synchronizing with another device, wholly or in part, at least one of: the collected positioning data, said at least one candidate spatial feature, and said at least one other spatial feature.

37. A method according to claim 1, further comprising accessing the database of spatial features to assist a location service for a mobile device.

38. A data processing system including a processor and associated memory, said data processing system being operable to update a database of spatial features, said spatial features being associated with a region, and said data processing system being programmed to perform a method of:
receiving positioning data that has been collected at a plurality of locations within the region;
processing the collected positioning data to identify at least one candidate spatial feature associated with the region;
identifying at least one other spatial feature corresponding to said at least one candidate spatial feature, said at least one other spatial feature and said at least one candidate spatial feature as a whole constituting matching spatial features;
processing said matching spatial features; and
updating the database of spatial features in dependence on the processing of said matching spatial features.

39. A non-transitory computer readable carrier storing computer program code for causing a data processing system to update a database of spatial features, said spatial features being associated with a region, said data processing system including a processor and associated memory, and the computer program code, when stored in said memory and executed by said processor, causing said data processing system to perform a method of:
receiving positioning data that has been collected at a plurality of locations within the region;
processing the collected positioning data to identify at least one candidate spatial feature associated with the region;
identifying at least one other spatial feature corresponding to said at least one candidate spatial feature, said at least one other spatial feature and said at least one candidate spatial feature as a whole constituting matching spatial features;
processing said matching spatial features; and
updating the database of spatial features in dependence on the processing of said matching spatial features.
